(19) United States
(12) Patent Application Publication
(10) Pub. No.: US 2006/0150483 A1
(43) Pub. Date: Jul. 13, 2006

(54) Tree support assembly

(76) Inventor: Esmail Zayer, San Jose, CA (US)

Correspondence Address: HENRY M. STANLEY, 165 EAST HILTON DRIVE, BOULDER CREEK, CA, 95006, US

(21) Appl. No.: 11/031,116

(22) Filed: Jan. 5, 2005

(51) Int. Cl. A01G 17/10

(52) U.S. Cl. 47/42

(57) ABSTRACT

A combination for extending between a plant support stake and a plant trunk has a bracket for surrounding the plant support stake and a trunk engaging strap for contacting and enclosing the plant trunk. Reinforcement structure is built into both the bracket and the strap. The strap includes a member that insulates the bracket from the tree trunk to avoid damage to the trunk through contact with the bracket when trunk movement is imposed by outside forces.

### BACKGROUND OF THE INVENTION

A number of publications are known which provide for support of growing plants and trees, particularly when they are in the early stages of growth. One such publication exists in U.S. Pat. No. 6,299,125, issued to the instant inventor, which discloses various apparatus for supporting young plants in their initial stages of growth by contacting and stabilizing the plant trunks. It is important for an apparatus of this type to engage and protect the trunk from damage when the trunk is moved about by outside forces such as wind or motion imparted by transit. It is also important to provide structure that extends from a plant support stake to the part of the apparatus that engages the tree trunk wherein such structure is strong enough to prevent undue tree trunk trauma imposed by these outside forces.

### SUMMARY OF THE INVENTION

Apparatus for use in supporting a plant trunk that is spaced from a plant support stake includes a bracket having a support stake end and a free end extending toward the plant trunk. The support stake end has an enlarged opening therein for surrounding the plant support stake and a pair of spaced elongate members having inwardly facing surfaces and opposing outer surfaces that extend from the enlarged opening. The pair of spaced elongate members each has a hole therein on a substantially common central axis and reinforcing ribs running along the length of the members.

In another aspect of the invention apparatus is described for use in supporting in place a plant trunk spaced from a plant support stake, including an elongate strap having a first end and a second end and a plant trunk protector on the elongate strap that is spaced from the first end. There is at least one reinforced section on the strap at the second end. The first end has a first hole therethrough between the first end and the plant trunk protector, and the at least one reinforced section has a second hole therethrough, so that when a fastener is passed through the first and second holes and the first and second ends are joined, a loop is formed for surrounding and supporting a plant trunk.

Further, the apparatus for use in supporting in place a plant trunk spaced from a plant support stake includes a bracket having a support stake end and a free end extending toward the plant trunk. The support stake end has an enlarged opening therein for surrounding the plant support stake and a pair of spaced elongate members with inwardly facing surfaces and opposed outer surfaces extending from the enlarged opening. The pair of spaced elongate members each has at least one hole therein on a substantially common central axis. Reinforcing ribs are formed along the length of the pair of spaced elongate members. An elongate strap has a first end and a second end and a plant trunk protector on the elongate strap spaced from the first end. At least one reinforced section is located on the strap at the second end. The first end has a first hole therein toward the first end from the plant trunk protector and the reinforced section has a second hole therein. Fastener means are provided for passing through the at least one hole in each of the pair of spaced elongate members and the first and second holes, so that a loop for surrounding a plant trunk is formed between the strap first and second ends.

In another aspect of the invention, apparatus is provided for use in supporting in place a plant trunk spaced from a plant support stake utilizing an adjustable hose clamp that has a slotted strap capable of surrounding the support stake and a strap loop size adjusting member having a coarse thread mounted thereon that is in engagement with the slotted strap. Further, the adjusting member has a shape on one end that is accessible by an adjustment tool to accomplish loop size adjustment. An improvement includes a first threaded extension on the strap loop size adjusting member, a second opposing threaded extension on the strap loop size adjusting member, and an adjustment tool accessible portion on the first threaded extension having a smaller diameter than the threads thereon.

In yet another aspect of the invention, apparatus is provided for use in supporting in place a plant trunk spaced from a plant support stake that includes a bracket for surrounding the plant support stake and an elongate strap for surrounding the plant trunk, wherein the elongate strap has first and second opposing ends. Also included are first and second bracket engaging means on the first and second opposing ends. A plant trunk protector is located toward the first opposing end of the elongate strap and a reinforced portion is located toward the second opposing end of the elongate strap. Means is provided for securing the first and second bracket engaging means to the bracket.

### BRIEF DESCRIPTION OF THE DRAWINGS

FIG. 1 is a perspective of one embodiment of the bracket of the present invention.

FIG. 2 is a section along the line 2-2 of FIG. 1.

FIG. 3A is a perspective of another embodiment of the bracket of the present invention.

FIG. 3B is a perspective of yet another embodiment of the bracket of the present invention.

FIG. 4 is a perspective of an old art hose clamp.

FIG. 5 is a perspective of an improved strap loop size adjusting member for use in the present invention.

FIG. 6A is a perspective of the detail of 6-6 in FIG. 5.

FIG. 6B is an alternate perspective of the detail 6-6 in FIG. 5.

FIG. 7 is a partial view of the apparatus of the present invention using the strap loop size adjusting member of FIG. 5.

FIG. 8 is a perspective of the trunk engaging clamp of the present invention.

FIG. 9 is a view of one embodiment of the combination of the bracket and trunk engaging strap of the present invention.

### DESCRIPTION OF THE PREFERRED EMBODIMENTS

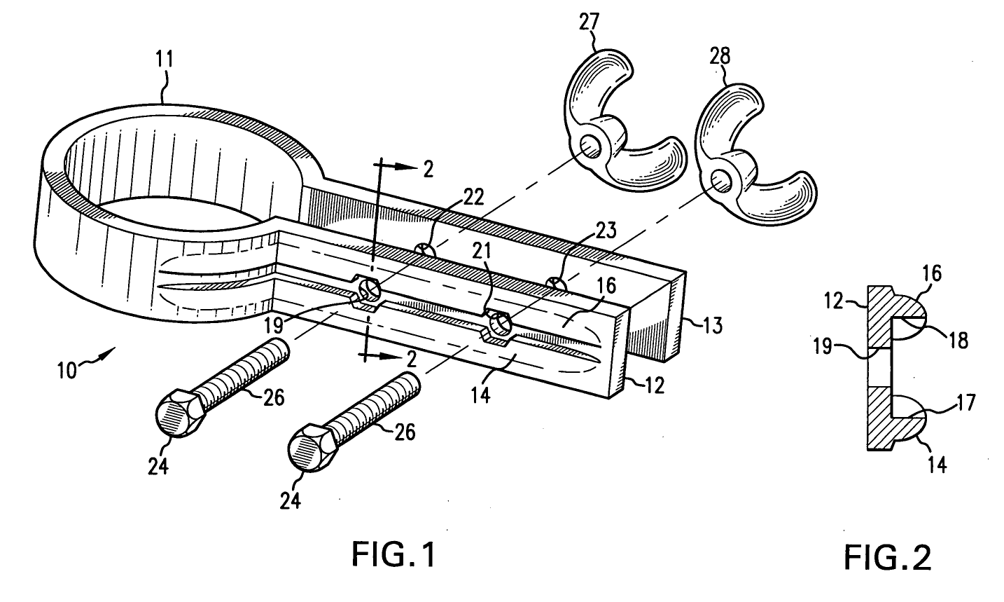

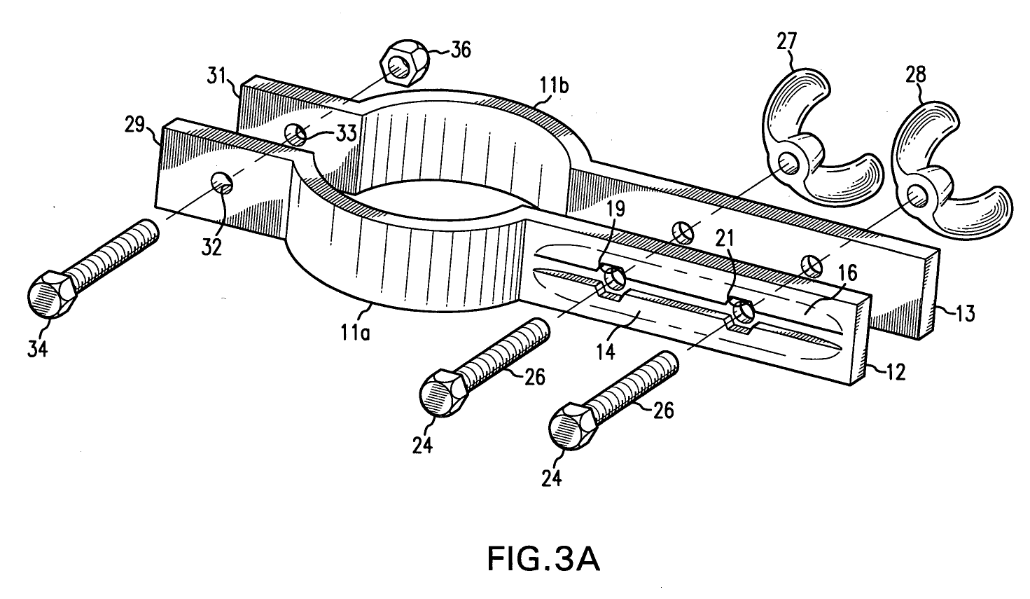

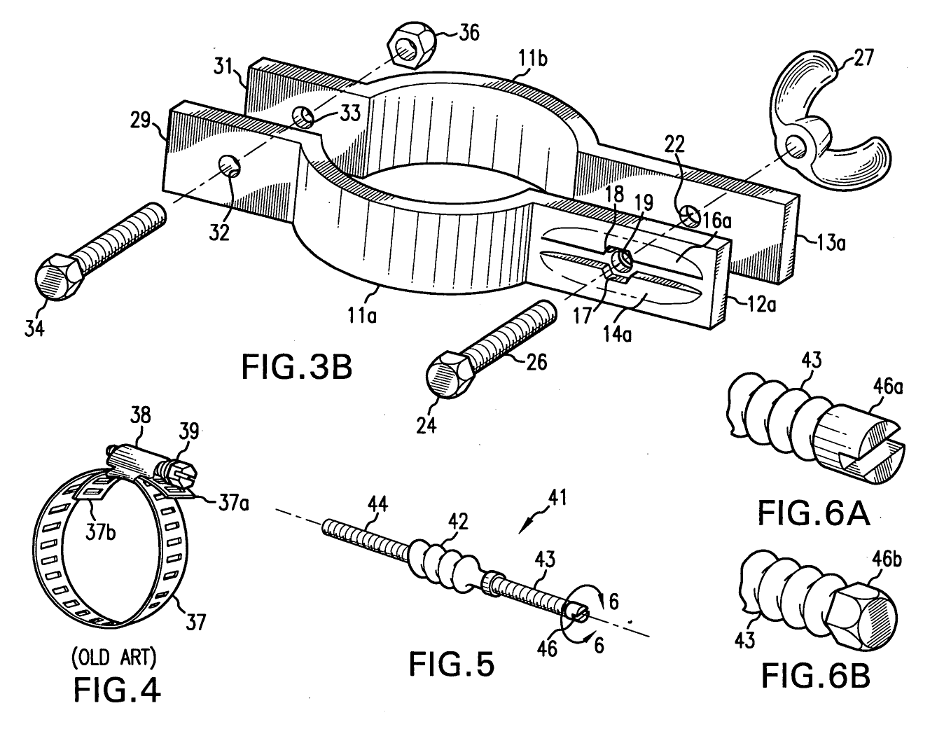

Occasionally the structure extending between a plant support stake and the trunk of a plant or tree to be supported is not strong enough to withstand motion imparted from outside forces, such as wind, etc. In such cases, the invention described herein is useful as it provides a strong link between the plant support stake and the tree trunk. Referring to FIG. 1 of the drawings, a bracket, shown generally at 10, is formed of flat stock having an enlarged opening portion 11 and a pair of extending and spaced elongate members 12 and 13. The elongate member 12 has a pair of ribs 14 and 16 running lengthwise on the extending member 12. Note that the ribs 14 and 16 in FIG. 1 extend along elongate member 12, through the bend in the flat stock where enlarged portion 11 and elongate member 12 are joined and along a part of the outer surface of the opening portion 11. The ribs 14 and 16 serve to stiffen elongate member 12 and to reinforce the part of the bracket 10 where elongate member 12 is joined to opening portion 10. The bracket 10 is thus able to withstand the aforementioned motion from wind, etc. without breaking, particularly at the junction of opening portion 11 and elongate member 12 where stress risers are likely to occur. While this feature is not shown in FIGS. 3A and 3B, it is understood that the extension of ribs 14 and 16 through the junction of opening portion 11 and elongate member 12 may be implemented in any of the other embodiments disclosed herein.

The section of FIG. 2 shows the ribs 14 and 16 in clearer detail, as well as formed portions 17 and 18 in each of the ribs 14 and 16 respectively. The formed portions 17 and 18 are located adjacent holes 19 and 21 formed in the elongate member 12. Holes 22 and 23 are formed in elongate member 13 in alignment with holes 19 and 21, respectively. The formed portions 18 and 17 in the reinforcing ribs 14 and 16 are shaped to accept one end of a fastener, such as a head 24 on a bolt 26. In this fashion, when the bolt or bolts 26 are inserted through the aligned holes 19/22 and 21/23 and are engaged at their exposed ends by a pair of wing nuts 27 and 28, the bolt heads 24 are seated in portions 17 and 18 and prevented from rotating in the holes. The wing nuts may then be securely tightened thereon.

Referring now to FIG. 3A, a modified version of the bracket shown in FIG. 1 will be described. The enlarged opening portion of the bracket is shown at 11a and 11b, having wall portions thereon since the bracket is made of flat stock as previously described. The enlarged opening portion of the bracket has a separation as seen in FIG. 3A that is spaced peripherally from the pair of spaced elongate members 12 and 13. A tab 29 extends outwardly from the portion 11a and another tab 31 extends outwardly from the portion 11b. Aligned holes 32 and 33 are formed in the tabs 29 and 31, respectively, through which a fastener such as bolt 34 is passed to be engaged by a nut 36, so that the diameter between the portions 11a and 11b may be adjusted to some extent to surround and fit support stakes of various diameters.

In FIG. 3B of the drawings, a modification of the embodiment shown in 3A is depicted. The embodiment of FIG. 3B is similar to that of FIG. 3A except that the spaced elongate members are shown at 12a and 13a in a shortened configuration. Only one pair of aligned holes 19 and 22 is shown wherein a single bolt 26 having a bolt head 24 is passed to be engaged by a wing nut 27. Shortened reinforcing ribs 14a and 16a are shown having formed portions 17 and 18 therein for capturing the bolt head 24 on bolt 26 in a fashion and for the purposes hereinbefore described in conjunction with FIG. 1. The remainder of the embodiment of FIG. 3B is similar to that of FIG. 3A as noted.

FIG. 4 is a depiction of old art, being a hose clamp such as that manufactured by IDEAL™ marked 300 SS. The hose clamp of FIG. 4 has a slotted strap 37 that is capable of surrounding a support stake for a plant or tree. The slotted strap has a free end 37a and a fixed end 37b that is fixed to a housing 38. Mounted within the housing 38 is a strap loop size adjusting member 39 having a coarse thread mounted thereon that is positioned to engage the slotted strap so that the free end 37a of the slotted strap may be advanced or retracted to thereby adjust the loop encompassed by the strap to a smaller or larger configuration. The strap loop size adjusting member has a shape on one end that is accessible by an adjustment tool to accomplish the aforesaid loop size adjustment. The strap loop size adjusting member 39 is removed from the old art assembly of FIG. 4 and replaced by a modified strap loop size adjusting member shown generally at 41 in FIG. 5. The member 41 has the aforementioned coarse thread 42 near the central portion thereof for contacting the slots in the slotted strap 37 to thereby advance and retract the free end of the slotted strap 37a as previously described. The coarse threads 42 are held in place for rotational movement only within the housing 38 (FIG. 4). A first threaded extension 43 is on the loop size adjusting member and a second opposing threaded extension 44 extends in an opposite direction from the adjusting member. The threaded extension member 43 has an adjustment tool accessible portion 46 on the free end thereof that may take any number of configurations such as those depicted in FIGS. 6A and 6B at 46a and 46b. It should be noted that the diameter of the accessible portion 46 must be no larger than the diameter of the threads on threaded member 43.

FIG. 8 shows an elongate strap 47 having a tree trunk protection member 48 formed near one end of the strap. A hole 49 is formed through the strap between the strap end and the tree trunk protection member 48. At the opposing end of the strap a plurality of reinforced sections 51a through 51e are shown. The reinforced sections are seen to be thicker than the other portions of the strap 47. Holes 52a through 52e are formed through each of the reinforced sections. The strap 47 is fabricated of some material that is easily bent into a loop and may be of an elastomeric material. The loop formed by the strap 47 is for the purpose of surrounding the trunk of a plant or tree to be engaged and supported.

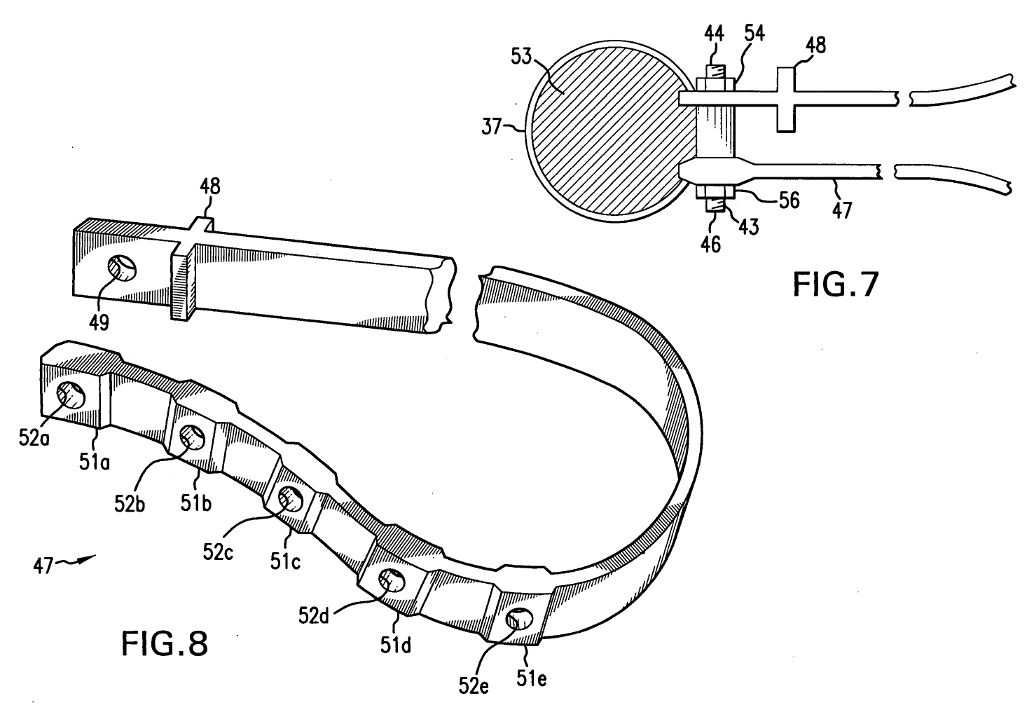

Referring now to FIG. 7, the manner in which the strap 47 is used in conjunction with the embodiment of FIGS. 4 and 5 will be described. A support post or stake 53 for plants and trees is shown in section extending through the opening in the slotted strap 37 shown in the embodiment of FIG. 4. The loop size adjusting member 39 is modified as discussed in the description of FIGS. 5, 6A and 6B. The hole 49 in the strap 47 is fitted over the threaded extension 44 and secured thereto by a nut 54. Depending on the size of the loop to be formed by the strap 47 to adequately contact and stabilize a tree trunk, one of the holes 52a through 52e (FIG. 8) is fitted over the threaded extension 43 and secured thereto by the nut 56. The remainder of the strap 47 beyond the hole 52a through 52e that is fit over the threaded extension 43 is cut off and discarded. Contact between the tree or plant trunk and the housing 38 is prevented by the plant trunk protector 48. The adjustment tool accessible member 46 is turned to snugly bring the slotted strap 37 up against the outside diameter of the plant support post 53.

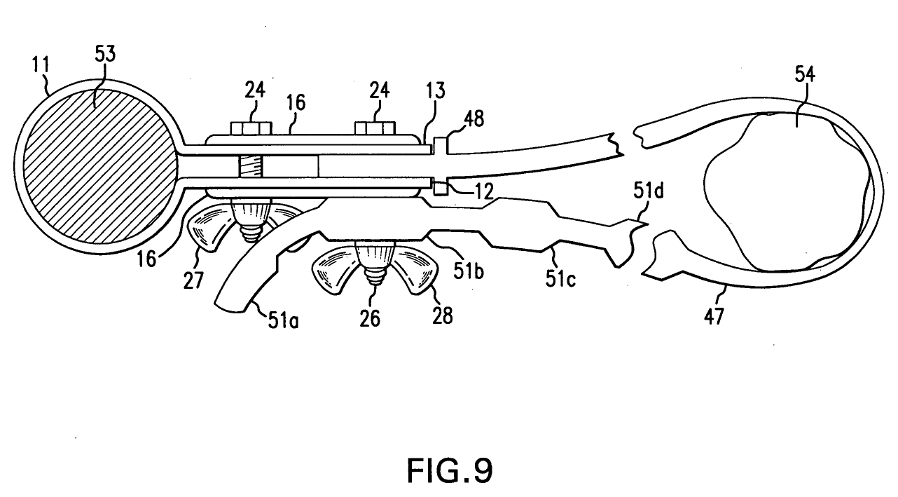

In FIG. 9 of the drawings, the strap 47 is seen in combination with the bracket embodiment of FIG. 1, item 10. The manner in which bracket embodiments of FIGS. 3A and 3B are used to extend between a plant support post 53 and a tree trunk shown at 54 in FIG. 9 are similar to that described for the bracket embodiment of FIG. 1. The enlarged portion 11 of the bracket 10 of FIG. 1 is placed in position surrounding the plant support stake 53. The end of the elongate strap 47 having the plant trunk protector 48 thereon is placed between the pair of spaced elongate members 12 and 13 and the hole 49 is aligned with the holes 21/23. The opposite end of the strap 47 is placed around a trunk 54 and one of the holes 52a through 52e is aligned with the holes 19/22. One of the bolts 26 is passed through the aligned holes 52b (in this instance), 19/22 and 49, until the head 24 of the bolt 26 is engaged in the formed portion illustrated at 17 and 18 in FIG. 2. The fastening of the end of the strap 47 between the elongate members is completed by applying the wing nut 28 to the free end of the bolt 26 and tightening the wing nut. The reinforced portion 51b (in this case) provides extra strength in that portion of the strap adjacent to the hold down position illustrated by the bolt 26 so that bending of the strap will not cause the strap to fatigue and fail at the hold down point. The reinforcing ribs 14 and 16 strengthen the spaced elongate members in bending mode and serve to provide a more rigid connection between the plant support stake 53 through the strap 47 surrounding the tree trunk 54. The second bolt 26 is seen passed through the aligned holes 19 and 22 in the elongate members and engaged by the wing nut 27 to ensure that the enlarged opening 11 in the bracket is kept snugly against the periphery of the plant support stake 53. As described hereinbefore, the bracket embodiments of FIGS. 3A and 3B may be used where the enlarged portion 11 of the bracket must be adjusted in diameter to snugly fit the plant support post 53. The unused portion of the strap 47 toward the end of the strap from reinforced portion 51b is shown in place in FIG. 9, but may be cut off after the installation is completed. Alternatively, the unused end portion of the strap 47 may be left in place in the event the loop formed by the strap around the tree trunk 54 needs to be enlarged in the future. It may also be seen in FIG. 9 that the ends of the elongate members 12 and 13 are isolated from any contact with the trunk 54 by the trunk protector portion 48. The trunk 54 is shown in FIG. 9 as spaced substantially from the ends of the elongate members for clarity.

Although the best mode contemplated for carrying out the present invention has been shown and described herein, it will be understood that modification and variation may be made without departing from what is regarded to be the subject matter of the invention.

What is claimed:

1. Apparatus for use in supporting in place a plant trunk spaced from a plant support stake, comprising
a bracket having a support stake end and a free end extending toward the plant trunk,
said support stake end having an enlarged opening therein for surrounding the plant support stake,
a pair of spaced elongate members on said free end extending from said support stake end and having facing inner surfaces and opposing outer surfaces,
means on said pair of spaced elongate members for accepting a fastener, and
reinforcing ribs formed along a length of at least one of said pair of spaced elongate members.

2. Apparatus as in claim 1, wherein said support stake end enlarged opening has a wall with a separation therein peripherally spaced from said pair of elongate members, further comprising
outwardly extending tabs attached to said bracket at each side of said separation,
means for fastening and for adjustably fixing said tabs in predetermined relative position so that said enlarged opening is adjustable in size to surround and contact the plant support stake.

3. Apparatus as in claim 1, wherein said means for accepting a fastener comprises at least one hole in each of said pair of spaced elongate members having a substantially common central axis, further comprising
an elongate strap having a first end and a second end,
a plant trunk protector on said elongate strap spaced from said first end,
at least one reinforced section on said strap at said second end,
said first end having a first hole therethrough between the first end and said plant trunk protector,
said at least one reinforced section having a second hole therethrough, and
fastener means for passing through said at least one hole in each of said pair of spaced elongate members and said first and second holes to form a loop between said first and second ends, whereby a plant trunk enclosed within said loop is supported thereby.

4. Apparatus as in claim 3, wherein said at least one reinforced section comprises
a plurality of spaced reinforced sections, said plurality of spaced reinforced sections each having a hole therethrough, so that said loop is adjustable between a reduced and an enlarged size according to which reinforced section hole said fastener means is passed through.

5. Apparatus as in claim 3, wherein said elongate strap comprises,
an elastomeric strap.

6. Apparatus as in claim 3, wherein said fastener means has a head end and wherein said reinforcing ribs are on said outer surfaces proximate to the periphery of said at least one hole to engage and rotationally fix said fastener means head end.

7. Apparatus as in claim 6, comprising
a formed portion of said reinforcing ribs adjacent said at least one hole for accepting said fastener means head end.

8. Apparatus as in claim 1, wherein said reinforcing ribs comprise
continuous ribs extending through the junction of said support stake end and said at least one of said pair of spaced elongate members and along a portion of said support stake end.

9. Apparatus for use in supporting in place a plant trunk spaced from a plant support stake, comprising
an elongate strap having a first end and a second end,
a plant trunk protector on said elongate strap spaced from said first end,
at least one reinforced section on said strap at said second end,
said first end having a first hole therethrough between the first end and said plant trunk protector,
said at least one reinforced section having a second hole therethrough, so that when a fastener is passed through said first and second holes and said first and second ends are joined, a loop is formed for surrounding and supporting a plant trunk.

10. Apparatus as in claim 9, wherein said at least one reinforced section comprises a plurality of spaced reinforced sections, said plurality of spaced reinforced sections each having a hole therethrough so that said loop is adjustable between a reduced and an enlarged size according to which reinforced section hole the fastener is passed through.

11. Apparatus as in claim 9, further comprising
a bracket having a support stake end and a free end extending toward the plant trunk,
said support stake end having an enlarged opening therein for surrounding the plant support stake,
a pair of spaced elongate members extending from said support stake end and having facing inner surfaces and opposing outer surfaces,
said pair of spaced elongate members each having at least one hole therein on a substantially common central axis,
reinforcing ribs formed along the length of at least one of said pair of spaced elongate members, and
first fastener means for passing through said at least one hole in each of said pair of spaced elongate members and said first and second holes in said elongate strap ends.

12. Apparatus as in claim 11, wherein said enlarged opening has a wall with a separation therein peripherally spaced from said pair of elongate members, further comprising
outwardly extending tabs attached to said wall at each side of said separation,
said outwardly extending tabs having aligned holes therein,
second fastener means for passing through said aligned holes for adjustably fixing said outwardly extending tabs in predetermined relative position, so that said enlarged opening is adjustable in size to surround and contact the plant support stake.

13. Apparatus as in claim 11, wherein said first fastener means comprises,
a head end, and wherein said reinforcing ribs are formed on said outer surfaces proximate to the periphery of said at least one hole to engage and rotationally fix said head end.

14. Apparatus as in claim 13, wherein said reinforcing ribs are positioned laterally from the periphery of said at least one hole, further comprising
a formed portion of said reinforcing ribs adjacent said at least one hole for accepting said fastener means head end.

15. Apparatus as in claim 9, wherein said elongate strap comprises
an elastomeric strap.

16. Apparatus as in claim 11, wherein said reinforcing ribs comprise
continuous ribs extending through the junction of said at least one of said spaced elongate members and said support stake end.

17. Apparatus for use in supporting in place a plant trunk spaced from a plant support stake, comprising
a bracket having a support stake end and a free end extending toward the plant trunk,
said support stake end having an enlarged opening therein for surrounding the plant support stake,
a pair of spaced elongate members extending from said support stake end and having facing inner surfaces and opposing outer surfaces,
said pair of spaced elongate members each having at least one hole therein on a substantially common central axis,
reinforcing ribs formed along the length of said pair of spaced elongate members,
an elongate strap having a first end and a second end,
a plant trunk protector on said elongate strap spaced from said first end,
at least one reinforced section on said strap at said second end,
said first end having a first hole therein spaced from said first end,
said reinforced section having a second hole therethrough, and
fastener means for passing through said at least one hole in each of said pair of spaced elongate members and said first and second holes, whereby a loop for surrounding a plant trunk is formed between said strap first and second ends.

18. Apparatus as in claim 17, wherein said at least one reinforced section comprises a plurality of spaced reinforced sections each having a hole therethrough, so that said loop is adjustable between a reduced and an enlarged size.

19. Apparatus as in claim 17, wherein said elongate strap comprises
an elastomeric strap.

20. Apparatus as in claim 17, wherein said fastener means has a head end and wherein said reinforcing ribs are on said outer surfaces proximate to the periphery of said at least one hole to engage and rotationally fix said fastener means head end.

21. Apparatus as in claim 20, comprising
a formed portion of said reinforcing ribs adjacent said at least one hole for accepting said fastener means head end.

22. Apparatus as in claim 17 wherein said reinforcing ribs comprise
continuous ribs extending through the junction of said pair of spaced elongate members and said support stake end.

23. Apparatus for use in supporting in place a plant trunk spaced from a plant support stake utilizing an adjustable hose clamp having a slotted strap capable of surrounding the support stake and a strap loop size adjusting member having a coarse thread mounted thereon in engagement with the slotted strap and a shape on one end accessible by an adjustment tool to accomplish loop size adjustment, the improvement comprising
a first threaded extension on the strap loop size adjusting member,
a second opposing threaded extension on the strap loop size adjusting member, and
an adjustment tool accessible member on said first threaded extension having a smaller diameter than the threads thereon.

24. Apparatus as in claim 23, further comprising
an elongate strap having a first end and a second end,
a plant trunk protector on said elongate strap spaced from said first end,
said first end being configured to engage one of said first and second threaded extensions,
said second end being configured to engage the other one of said first and second threaded extensions, and
means for securing said first and second ends on the engaged ones of said first and second threaded extensions.

25. Apparatus as in claim 24, further comprising
a reinforced section on said elongate strap at said second end.

26. Apparatus as in claim 24, wherein said elongate strap comprises,
an elastomeric strap.

27. Apparatus for use in supporting in place a plant trunk spaced from a plant support stake, comprising
a bracket for surrounding the plant support stake,
an elongate strap for surrounding the plant trunk, said elongate strap having first and second opposing ends,
first and second bracket engaging means on said first and second opposing ends,
a plant trunk protector toward said first opposing end of said elongate strap,
a reinforced portion toward said second opposing end of said elongate strap, and
means for securing said first and second bracket engaging means to said bracket.

28. Apparatus as in claim 27, wherein said bracket further comprises
an extension member having a free end,
a reinforcing rib on said extension member,
means on said free end for accepting said means for securing.

29. Apparatus as in claim 28, wherein said means for accepting comprises
a formed portion of said reinforcing rib,
said extension member having a hole therein adjacent said formed portion, so that said means for securing is engaged and fixed in place on said extension member.

30. Apparatus as in claim 28, wherein said extension member is joined to said bracket at a bend therebetween, said reinforcing rib comprising,
a continuous rib extending through said bend.
